(19) United States
(12) Patent Application Publication
(10) Pub. No.: US 2025/0272170 A1
(43) Pub. Date: Aug. 28, 2025

(54) ANCHOR SHARING METHOD AND APPARATUS

(71) Applicant: Beijing Zitiao Network Technology Co., Ltd., Beijing (CN)

(72) Inventor: Zhanyi YAN, Beijing (CN)

(21) Appl. No.: 19/064,263

(22) Filed: Feb. 26, 2025

(30) Foreign Application Priority Data
Feb. 26, 2024 (CN) 202410211636.4

(51) Int. Cl. G06F 9/54; G06T 19/00

(52) U.S. Cl. CPC G06F 9/544; G06T 19/006

(57) ABSTRACT

An anchor sharing method includes: a sending end determines at least one target anchor; the sending end acquires target map data according to the target anchor, where the target map data includes: first map data corresponding to the target anchor, and second map data associated with the first map data; the sending end uploads a target anchor identifier of the target anchor, the target map data, and anchor attribute data corresponding to the target map data to a server; a receiving end receives the target anchor identifier sent by the server; if the target anchor corresponding to the target anchor identifier is an anchor in a coordinate system of downloaded map data, the receiving end acquires the anchor attribute data of the target anchor from the server according to the target anchor identifier; and the receiving end displays the target anchor according to the anchor attribute data and the downloaded map data.

### CROSS-REFERENCE TO RELATED APPLICATION

The present disclosure claims priority of the Chinese Patent Application No. 202410211636.4 filed with the Chinese Patent Office on Feb. 26, 2024, the entire disclosure of which is incorporated by reference in the present disclosure.

### TECHNICAL FIELD

Embodiments of the present disclosure relate to the technical field of computer technology, and in particular, to an anchor sharing method and apparatus.

### BACKGROUND

In an augmented reality scene, an anchor function is used for binding a virtual pose with a real position in a real-world environment, and displaying a virtual object according to the virtual pose when a user arrives at the real position next time. The virtual pose may be understood as an anchor.

In prior arts, an anchor can be shared between different user terminals. Specifically, a user terminal that sends the anchor may be referred to as a sending end, and a user terminal that receives the anchor is referred to as a receiving end. The sending end can send a local anchor and map data corresponding to the anchor to the receiving end through forwarding by a server.

However, the above-mentioned solution has a problem of low accuracy of the shared data.

### SUMMARY

Embodiments of the present disclosure provide an anchor sharing method and apparatus, which can improve the accuracy of shared data.

In a first aspect, embodiments of the present disclosure provide an anchor sharing method, including:
determining at least one target anchor;
acquiring target map data according to the at least one target anchor, where the target map data includes: first map data corresponding to the target anchor, and second map data associated with the first map data; and
uploading a target anchor identifier of the target anchor, the target map data, and anchor attribute data corresponding to the target map data to a server.

In a second aspect, embodiments of the present disclosure provide an anchor sharing method, including:
receiving a target anchor identifier sent by a server;
in response to a target anchor corresponding to the target anchor identifier being an anchor in a coordinate system of downloaded map data, acquiring anchor attribute data of the target anchor from the server according to the target anchor identifier; and
displaying the target anchor according to the anchor attribute data and the downloaded map data.

In a third aspect, embodiments of the present disclosure provide an anchor sharing apparatus, including:
a target anchor determination module, configured to determine at least one target anchor;
a map acquiring module, configured to acquire target map data according to the at least one target
anchor, where the target map data includes: first map data corresponding to the target anchor, and second map data associated with the first map data; and
a first uploading module, configured to upload a target anchor identifier of the target anchor, the target map data, and anchor attribute data corresponding to the target map data to a server.

In a fourth aspect, embodiments of the present disclosure provide an anchor sharing apparatus, including:
an anchor receiving module, configured to receive a target anchor identifier sent by a server;
an attribute acquiring module, configured to: in response to a target anchor corresponding to the target anchor identifier being an anchor in a coordinate system of downloaded map data, acquire anchor attribute data of the target anchor from the server according to the target anchor identifier; and
an anchor displaying module, configured to display the target anchor according to the anchor attribute data and the downloaded map data.

In a fifth aspect, embodiments of the present disclosure provide an electronic device, including: at least one processor and a memory; where
the memory stores computer-executable instructions; and
the at least one processor executes the computer-executable instructions stored in the memory, so
that the electronic device implements the method according to the first aspect or the second aspect.

In a sixth aspect, embodiments of the present disclosure provide an anchor sharing system, including: a sending end, a receiving end and a server, where the sending end is configured to execute the method according to the first aspect, and the receiving end is configured to execute the method according to the second aspect.

In a seventh aspect, embodiments of the present disclosure provide a computer-readable storage medium, where computer-executable instructions are stored in the computer-readable storage medium, and when a processor executes the computer-executable instructions, a computing device is caused to implement the method according to the first aspect or the second aspect.

In an eighth aspect, embodiments of the present disclosure provide a computer program, where the computer program is configured to implement the method according to the first aspect or the second aspect.

### BRIEF DESCRIPTION OF DRAWINGS

In order to illustrate the technical solutions in the embodiments of the present disclosure or in the prior arts more clearly, the drawings that need to be used in the description of the embodiments or the prior arts will be briefly introduced in the following. Obviously, the drawings in the following description are some embodiments of the present disclosure, and for those of ordinary skill in the art, other drawings can be obtained according to these drawings without creative effort.

FIG. 1 is a schematic diagram of anchor sharing provided by an embodiment of the present disclosure;

FIG. 2 is a schematic diagram of space division provided by an embodiment of the present disclosure;

FIG. 3, FIG. 4 and FIG. 5 are flowcharts of steps of three anchor sharing methods provided by embodiments of the present disclosure;

FIG. 6 and FIG. 7 are structural block diagrams of two anchor sharing apparatuses provided by embodiments of the present disclosure; and

FIG. 8 is a structural block diagram of an electronic device provided by an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below in combination with the drawings in the embodiments of the present disclosure. Obviously, the described embodiments are part of the embodiments of the present disclosure, but not all of the embodiments. Based on the embodiments in the present disclosure, all other embodiments obtained by those of ordinary skill in the art without creative work shall fall within the protection scope of the present disclosure.

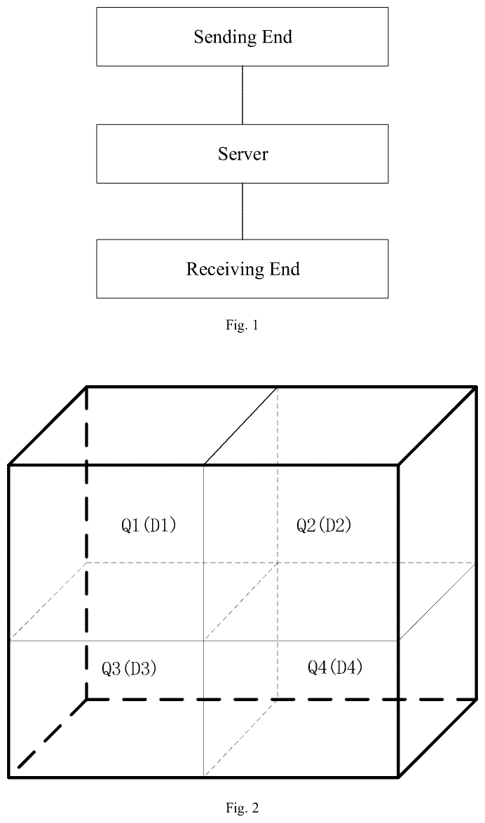

The embodiments of the present disclosure are used to share an anchor and related data between a sending end and a receiving end. FIG. 1 is a schematic diagram of anchor sharing provided by an embodiment of the present disclosure. As shown in FIG. 1, the sending end and the receiving end are both communicatively connected to a server. In the process of anchor sharing, firstly, a user operates on the sending end to determine a shared anchor, and the sending end can upload the shared anchor and the map data corresponding to the anchor to the server; then, the server sends the anchor and the corresponding map data to the receiving end.

It can be understood that, there may be one or more of the above-mentioned sending ends and receiving ends, and the number of the above-mentioned sending end and receiving end is not limited in the embodiments of the present disclosure.

However, the above-mentioned solution has a problem of low accuracy of the shared data.

In order to solve the above problem, in the embodiments of the present disclosure, not only the first map data corresponding to the anchor is shared to the receiving end, but also the second map data associated with the first map data is shared to the receiving end. In this way, when sharing the anchor, the integrity of the map data can be improved, which is helpful to improve the accuracy of the shared data.

The anchor sharing method in the embodiments of the present disclosure is implemented by two user devices: a sending end and a receiving end. The sending end and the receiving end may be at least one of the following devices: an AR (Augmented Reality) device, an XR (Extended Reality) device, and an MR (Mixed Reality) device.

The map data in the embodiments of the present disclosure may be map data of any spatial region, and the map data may be a point cloud map. The point cloud map is used to represent a map through feature points of an environment, and the feature points are points with contrast extracted from the environment images collected by an image collection apparatus. Thus, these feature points may form a three-dimensional point cloud, i.e., the point cloud map, when recorded in a three-dimensional coordinate system.

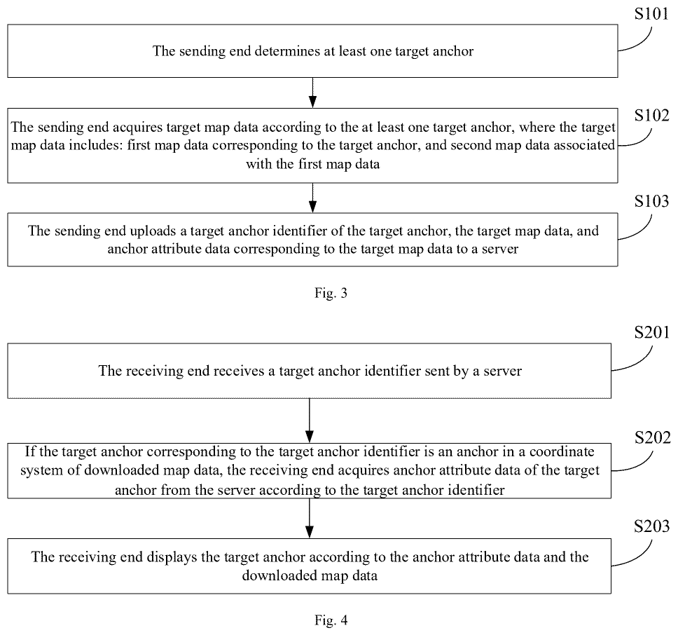

In an example, for a space, any spatial region is divided into multiple regions, and each region corresponds to a piece of map sub-data. FIG. 2 is a schematic diagram of space division provided by an embodiment of the present disclosure. As shown in FIG. 2, a space may be divided into four regions of Q1, Q2, Q3, and Q4, then Q1, Q2, Q3, and Q4 respectively correspond to map data D1, D2, D3, and D4. The length, width, and height of each region are fixed, for example, the length of each region may be 5 meters, the width may be 5 meters, and the height may be 3 meters, so as to divide the space into multiple regions of 5 meters×5 meters×3 meters.

In the scenario shown in FIG. 2, the map data in the embodiments of the present disclosure may be the map data in the regions obtained by the above division, for example, the map data D1, D2, D3, and D4, or may be the map data corresponding to the entire space formed by the map data D1, D2, D3, and D4. After each startup of the user terminal, when the user carries the sending end and moves in the space as shown in FIG. 2, the map data of each region and the anchor corresponding to the map data may be continuously constructed. The map data of various regions constructed after this startup may form the map data corresponding to the entire space after this startup. Therefore, when the user terminal restarts for N times, N piece(s) of map data of the entire space may be obtained. N is a positive integer greater than or equal to 1.

It can be understood that there is no overlapping region between different regions shown in FIG. 2, but in practical applications, there may be overlapping regions between different regions.

The technical solutions of the embodiments of the present disclosure and how the technical solutions of the present disclosure solve the above technical problems are explained in detail below with specific embodiments. The following specific embodiments may be combined with each other, and the same or similar concepts or processes may not be repeated in some embodiments. The embodiments of the present disclosure will be described below in combination with the drawings.

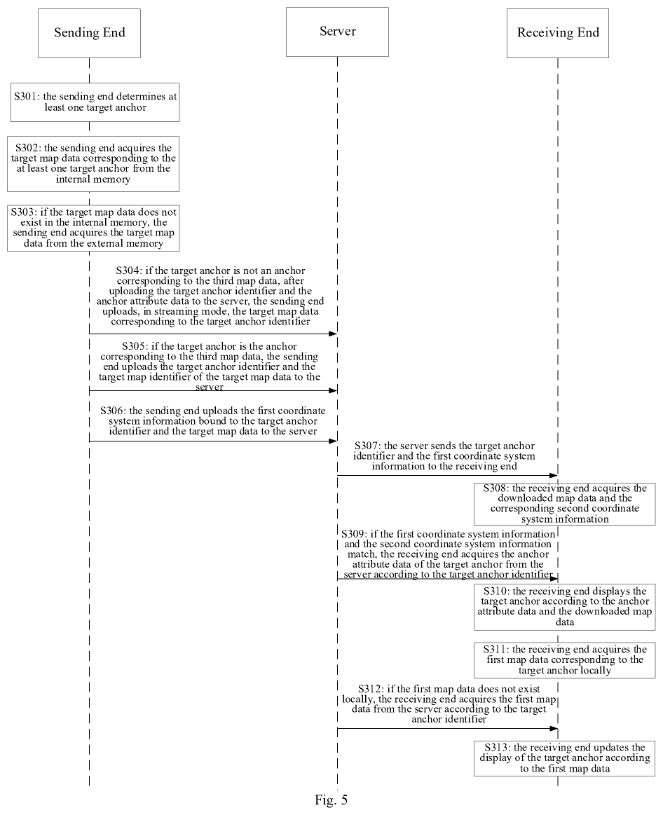

FIG. 3 is a flowchart of steps of an anchor sharing method provided by an embodiment of the present disclosure, which is applied to a sending end. As shown in FIG. 3, the anchor sharing method includes:

S101: the sending end determines at least one target anchor.

The target anchor is an anchor to be shared by the sending end, which may be selected by a user on the sending end, and therefore, may also be referred to as a cloud anchor. At least one target anchor belongs to one or more anchor groups, and each anchor group includes one or more anchors. When the at least one target anchor belongs to multiple anchor groups, the sharing of multiple groups of anchors may be realized, and multiple groups of anchors may be shared at once, which is helpful to improve the sharing efficiency of anchors.

The above-mentioned at least one target anchor includes at least one of the following: an anchor of at least one type, an anchor within at least one region, or an anchor selected by a user.

The anchor of at least one type may be obtained by dividing according to the function of the anchor. For example, an anchor for room calibration may be used as an anchor of one type, and an anchor for virtual object display may be used as an anchor of another type. In this way, an anchor may be shared based on the type. The user may select one or more types, so that one or more target anchors may be shared, thereby improving the user's operation complexity when the anchors are shared. For example, the user may select an anchor type of room calibration, so that all room calibration anchors may be used as target anchors for sharing. The user does not need to select anchors one by one, but only needs to select the type, which can reduce the user's operation complexity.

The anchor within at least one region may be an anchor within any region, and a user may select the region to realize the sharing of all anchors within the region. Similarly, the user's operation complexity when selecting an anchor may also be reduced.

The anchor selected by the user may be an anchor of any type or any region selected by the user.

S102: the sending end acquires target map data according to the at least one target anchor, where the target map data includes: first map data corresponding to the target anchor, and second map data associated with the first map data.

Each target anchor corresponds to at least one piece of first map data, and the first map data corresponding to each target anchor is the map data corresponding to the target anchor, that is, the map data that needs to be used by the receiving end to retrieve the target anchor.

Each piece of first map data corresponds to at least one piece of second map data.

In some implementations, the target map data of an anchor that has been identified, positioned, and loaded into the memory may exist in an internal memory or an external memory, so the process of the sending end acquiring the target map data according to the at least one target anchor may include: firstly, the sending end acquires the target map data corresponding to the at least one target anchor from the internal memory; then, if the target map data does not exist in the internal memory, the sending end acquires the target map data from the external memory. In this way, the sending end can preferentially read the target map data that has been loaded into the internal memory from the internal memory, which can improve the sharing efficiency of the anchor. When the target map data does not exist in the memory, the target map data can be read from the external memory, which can ensure the sharing success rate of the anchor as much as possible.

S103: the sending end uploads a target anchor identifier of the target anchor, the target map data, and anchor attribute data corresponding to the target map data to a server.

The target anchor identifier is an identifier of the target anchor, and is used to uniquely represent a target anchor. The anchor attribute data includes the anchor attribute data of all anchors corresponding to the target map data, and is used to display these anchors. Each anchor has corresponding anchor attribute data for displaying the anchor. The anchor attribute data may include: a position and a posture, which may also be referred to as pose data. The position may be represented by coordinates in a three-dimensional coordinate system, and the posture may be represented by a three-dimensional vector, which are used to indicate that a virtual object corresponding to the anchor is displayed in the position in the three-dimensional coordinate system with the posture represented by the three-dimensional vector.

Specifically, the sending end may upload the target anchor identifier, the target map data, and the anchor attribute data corresponding to the target map data to the server through a pre-established communication connection.

As can be seen from the above description, in the embodiment of the present disclosure, data of multiple dimensions is sent to ensure the integrity of the data sent when the anchor is shared, which is helpful to improve the accuracy of anchor sharing.

In a first aspect, the sending end sends the shared target anchor identifier to the receiving end through the server to indicate the shared target anchor to the receiving end.

In a second aspect, the sending end also sends the first map data and the anchor attribute data corresponding to the target anchor identifier to the receiving end through the server, to assist the receiving end to retrieve the target anchor through the first map data, and to use the anchor subsequently through the anchor attribute data.

In a third aspect, the sending end also sends the second map data associated with the first map data to the receiving end through the server, to send more map data, which can facilitate the use of the anchor by the receiving end.

In some implementations, the uploading the target anchor identifier, the target map data, and the anchor attribute data corresponding to the target map data to the server may be implemented through the following process: firstly, the sending end acquires third map data, where the third map data includes map data that has been uploaded to the server and has an overlapping area with the first map data; then, the sending end judges whether the target anchor is an anchor corresponding to the third map data. If the target anchor is not the anchor corresponding to the third map data, it means that the first time of anchor sharing for the third map data is performed. At this time, the sending end needs to upload the target anchor identifier of the target anchor, the target map data, and the anchor attribute data corresponding to the target map data to the server. That is to say, the first map data corresponding to the target anchor has not been uploaded before, so when the target anchor is shared, it is necessary not only to upload the target anchor identifier, but also to upload the target map data corresponding to the target anchor identifier and the anchor attribute data corresponding to the target map data. In this way, the complete sharing of the anchor can be realized.

However, if the target anchor is the anchor corresponding to the third map data, it means that the target anchor is shared again for the third map data. At this time, the sending end may upload the target anchor identifier and the target map identifier of the target map data to the server without repeatedly uploading the target map data and the anchor attribute data. In this way, the repeated uploading of the target map data and the anchor attribute data can be avoided, thereby saving uploading resources and improving uploading efficiency.

It should be noted that since different map data corresponding to the same anchor usually has overlapping areas, the third map data acquired in the embodiment of the present disclosure is not only the map data that has been uploaded to the server, but also the map data having an overlapping area with the first map data. In this way, the data amount of the third map data may be reduced, thereby shortening the time required to determine the correspondence between the target anchor and the third map data, and further improving the data uploading efficiency.

Optionally, in the process of uploading the target anchor identifier, the target map data, and the anchor attribute data corresponding to the target map data to the server, it may be specifically: the sending end first uploads the target anchor identifier and the anchor attribute data to the server, and then the sending end uploads, in streaming mode, the target map data corresponding to the target anchor identifier. The uploading order of the target map data is consistent with the uploading order of the corresponding target anchor identifier.

The uploading order of the target anchor identifier may be flexibly determined, for example, it may be determined according to the following factors: a series number of the target anchor identifier, a position of the target anchor corresponding to the target anchor identifier, or a time when the user selects it for sharing, etc. After the uploading order of the target anchor identifier is determined, the uploading order of the target map data may be determined. Specifically, the target map data corresponding to the target anchor identifier in a front position of the uploading order is also in a front position of the uploading order; and the target map data corresponding to the target anchor identifier in a rear position of the uploading order is also in a rear position of the uploading order. For example, for target anchor identifiers M1, M2, M3, M4, and M5, the corresponding target map data are denoted as D1, D2, D3, D4, and D5, respectively. When the uploading order of the target anchor identifiers M1, M2, M3, M4, and M5 is M1, M2, M5, M4, M3, the uploading order of the corresponding target map data is D1, D2, D5, D4, D3.

It can be understood that the data amount of the target map data is larger than that of the target anchor identifier and the anchor attribute data. In this way, the target map data with a large amount of data is uploaded in streaming mode, so that the receiving end can download part of the uploaded target map data first in the process of uploading in streaming mode, thus realizing a strategy of downloading while uploading, thereby saving downloading time and improving the efficiency of anchor sharing.

In conclusion, the uploading order of the above-mentioned target map data is consistent with the uploading order of the corresponding target anchor identifier, which can ensure that the target map data of the target anchor identifier uploaded first is downloaded preferentially, ensure the uploading order consistency and the downloading order consistency of the anchor identifier and the map data, and is helpful to improve the accuracy of anchor sharing.

In some implementations, in the process of uploading the target anchor identifier, the target map data, and the anchor attribute information, coordinate system information may also be uploaded. Specifically, the sending end acquires first coordinate system information, and uploads the first coordinate system information bound to the target anchor identifier and the target map data to the server. The first coordinate system information is used to indicate the coordinate system where the target anchor and the target map data are located. In this way, the receiving end can align multiple pieces of target map data according to the received first coordinate system information, and unify the coordinate system, so that the receiving end can accurately perform subsequent processing on the anchor.

After the server receives the target map data, the anchor attribute data, the first coordinate system information, etc., it may store them locally. And the server periodically judges whether there are download records for the target map data, the anchor attribute data, and the first coordinate system information. If the server judges that there is no download record for the target map data, the server will delete the target map data, and the anchor attribute data corresponding to the target map data and the first coordinate information will be deleted. In this way, the storage resources of the server can be saved as much as possible, and data redundancy of the server can be avoided.

FIG. 4 is a flowchart of steps of another anchor sharing method provided by an embodiment of the present disclosure. As shown in FIG. 4, the anchor sharing method may include:

S201: the receiving end receives a target anchor identifier sent by a server.

When the server receives the target anchor identifier uploaded by the sending end, the server can send the target anchor identifier to the receiving end first, to indicate that the anchor to be shared to the receiving end is the target anchor corresponding to the target anchor identifier, so that the receiving end downloads the related data of the target anchor identifier.

S202: if the target anchor corresponding to the target anchor identifier is an anchor in a coordinate system of downloaded map data, the receiving end acquires anchor attribute data of the target anchor from the server according to the target anchor identifier.

It can be understood that, when the target anchor is an anchor in the coordinate system of the downloaded map data, it means that the coordinate system of the target anchor may be consistent with the coordinate system of the downloaded map data, so that the target anchor can be displayed in the coordinate system of the downloaded map data. At this time, the receiving end needs to acquire the anchor attribute data required for displaying the target anchor first.

The anchor attribute data may include a position and a posture of the target anchor, to indicate the receiving end to display the target anchor at the position in the downloaded map data with the posture.

In some implementations, the above-mentioned S202 may include the following steps: firstly, the receiving end receives first coordinate system information corresponding to the target anchor identifier sent by the server; then, the receiving end acquires the downloaded map data and second coordinate system information corresponding to the downloaded map data; finally, the receiving end matches the first coordinate system information with the second coordinate system information. If the first coordinate system information and the second coordinate system information match, the receiving end acquires the anchor attribute data of the target anchor from the server according to the target anchor identifier.

As can be seen from the above description of the sending end uploading the anchor, the sending end also uploads the first coordinate system information bound to the target anchor identifier to the server in addition to uploading the target anchor identifier, the target map data, and the anchor attribute data. Therefore, the receiving end may acquire the first coordinate system information corresponding to the target anchor identifier from the server.

Correspondingly, the downloaded map data is the map data that the receiving end pre-downloads from the server, and every time the receiving end downloads the map data from the server, the receiving end also needs to download the second coordinate system information corresponding to the map data from the server. The second coordinate system information is the coordinate system information of the downloaded map data. As can be seen from the above description, every time the sending end uploads the target map data, the sending end also uploads the first coordinate system information of the target map data to the server. Therefore, the second coordinate system information of the downloaded map data is the first coordinate system information downloaded from the server.

As can be seen from the above description, when the first coordinate system information and the second coordinate system information match, it means that the target anchor identifier and the downloaded map data are in the same coordinate system. At this time, acquiring the anchor attribute data and displaying the target anchor, which can ensure the display accuracy of the target anchor.

S203: the receiving end displays the target anchor according to the anchor attribute data and the downloaded map data.

Specifically, the receiving end may display the target anchor, with the posture, at the position in the downloaded map data. The displaying the target anchor may be understood as displaying the virtual object corresponding to the target anchor.

It can be seen that, with the above-mentioned solution, the receiving end can preferentially display the target anchor when the shared target anchor is located in the coordinate system of the downloaded map data, which can shorten the display time delay of the target anchor and improve the display efficiency of the target anchor.

However, there may be some small errors in the display of the above-mentioned target anchor. In order to further improve the display accuracy of the target anchor, after displaying the target anchor according to the anchor attribute data and the downloaded map data, the first map data corresponding to the target anchor may also be acquired, and the display of the target anchor may be updated according to the first map data. Actually, updating the display of the target anchor according to the first map data may be understood as updating the position and posture of the target anchor. Since the first map data is the map data corresponding to the target anchor and is used to retrieve and display the target anchor, the position and posture of the target anchor may be accurately determined, which is helpful to update the target anchor again after the target anchor is quickly displayed. In this way, the display efficiency of the target anchor may be improved, and the accuracy of the target anchor may be further ensured.

In some implementations, the above-mentioned first map data may be acquired through the following process: the receiving end acquires the first map data corresponding to the target anchor locally. If the first map data does not exist locally, the receiving end acquires the first map data from the server according to the target anchor identifier. It can be seen that in the embodiment of the present disclosure, the downloaded first map data may be preferentially acquired locally, and if the first map data has not been downloaded before, the first map data is downloaded from the server for the first time. In this way, the number of times of downloading the first map data from the server may be reduced as much as possible, network resources may be saved, the download time delay of the first map data may be reduced, and the download efficiency of the first map data may be improved.

It can be seen that when the receiving end acquires the shared target anchor identifier, the anchor attribute data and the first map data, it may store them locally, so as to facilitate subsequent reuse, and improve the efficiency of the receiving end displaying the anchor.

FIG. 5 is a flowchart of steps of another anchor sharing method provided by an embodiment of the present disclosure. As shown in FIG. 5, the anchor sharing method may include:

S301: the sending end determines at least one target anchor.

S302: the sending end acquires the target map data corresponding to the at least one target anchor from the internal memory.

S303: if the target map data does not exist in the internal memory, the sending end acquires the target map data from the external memory.

S304: if the target anchor is not an anchor corresponding to the third map data, after uploading the target anchor identifier and the anchor attribute data to the server, the sending end uploads, in streaming mode, the target map data corresponding to the target anchor identifier.

S305: if the target anchor is the anchor corresponding to the third map data, the sending end uploads the target anchor identifier and the target map identifier of the target map data to the server.

S306: the sending end uploads the first coordinate system information bound to the target anchor identifier and the target map data to the server.

S307: the server sends the target anchor identifier and the first coordinate system information to the receiving end.

S308: the receiving end acquires the downloaded map data and the corresponding second coordinate system information.

S309: if the first coordinate system information and the second coordinate system information match, the receiving end acquires the anchor attribute data of the target anchor from the server according to the target anchor identifier.

S310: the receiving end displays the target anchor according to the anchor attribute data and the downloaded map data.

S311: the receiving end acquires the first map data corresponding to the target anchor locally.

S312: if the first map data does not exist locally, the receiving end acquires the first map data from the server according to the target anchor identifier.

S313: the receiving end updates the display of the target anchor according to the first map data.

It should be noted that the order of the steps shown in FIG. 5 above may be flexibly adjusted on the basis of being independent of each other. In addition, for the above-mentioned anchor sharing method, reference may be made to the corresponding description of the anchor sharing method shown in FIG. 3 and FIG. 4 above, which will not be repeated here.

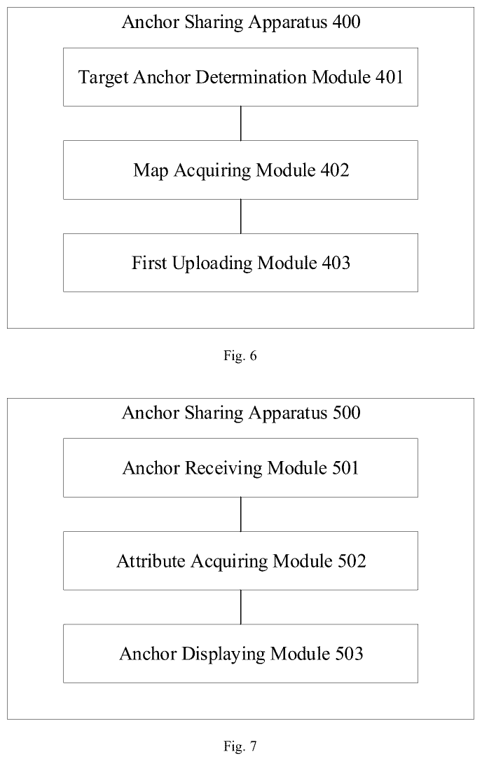

Corresponding to the anchor sharing method of the embodiment corresponding to FIG. 3, FIG. 6 is a structural block diagram of an anchor sharing apparatus provided by an embodiment of the present disclosure, which is applied to the sending end. For the convenience of description, only the parts related to the embodiments of the present disclosure are shown. Referring to FIG. 6, the anchor sharing apparatus 400 includes:

a target anchor determination module 401, configured to determine at least one target anchor;

a map acquiring module 402, configured to acquire target map data according to the at least one target anchor, where the target map data includes: first map data corresponding to the target anchor, and second map data associated with the first map data; and

a first uploading module 403, configured to upload a target anchor identifier of the target anchor, the target map data, and anchor attribute data corresponding to the target map data to a server.

Optionally, the first uploading module 403 is further configured to:

acquire third map data, where the third map data includes map data that has been uploaded to the server and has an overlapping area with the first map data; and if the target anchor is not an anchor corresponding to the third map data, upload the target anchor identifier of the target anchor, the target map data, and the anchor attribute data corresponding to the target map data to the server.

Optionally, the apparatus further includes:

a second uploading module, configured to: if the target anchor is the anchor corresponding to the third map data, upload the target anchor identifier and a target map identifier of the target map data to the server.

Optionally, the map acquiring module 402 is further configured to:

acquire the target map data corresponding to the at least one target anchor from an internal memory; and if the target map data does not exist in the internal memory, acquire the target map data from an external memory.

Optionally, the apparatus further includes:
a coordinate acquiring module, configured to acquire first coordinate system information, where
the first coordinate system information is used to indicate a coordinate system where the target anchor and the target map data are located; and
a third uploading module, configured to upload the first coordinate system information bound to the target anchor identifier and the target map data to the server.

Optionally, the first uploading module 403 is further configured to:
after uploading the target anchor identifier and the anchor attribute data to the server, uploading, in streaming mode, the target map data corresponding to the target anchor identifier, where an uploading order of the target map data is consistent with an uploading order of the corresponding target anchor identifier.

Optionally, the at least one target anchor includes at least one of the following: an anchor of at least one type, an anchor within at least one region, or an anchor selected by a user.

The anchor sharing apparatus provided in this embodiment may be used to execute the technical solutions of the embodiment corresponding to FIG. 3, with similar implementation principles and technical effects, which will not be repeated here in this embodiment.

Corresponding to the anchor sharing method of the embodiment corresponding to FIG. 4, FIG. 7 is a structural block diagram of an anchor sharing apparatus provided by an embodiment of the present disclosure, which is applied to a receiving end. For the convenience of description, only the parts related to the embodiments of the present disclosure are shown. Referring to FIG. 7, the anchor sharing apparatus 500 includes:

an anchor receiving module 501, configured to receive a target anchor identifier sent by a server;

an attribute acquiring module 502, configured to: if a target anchor corresponding to the target anchor identifier is an anchor in a coordinate system of downloaded map data, acquire anchor attribute data of the target anchor from the server according to the target anchor identifier; and

an anchor displaying module 503, configured to display the target anchor according to the anchor attribute data and the downloaded map data.

Optionally, the apparatus further includes:
a first map acquiring module, configured to: after displaying the target anchor according to the anchor attribute data and the downloaded map data, acquire first map data corresponding to the target anchor; and
a target anchor updating module, configured to update the display of the target anchor according to the first map data.

Optionally, the first map acquiring module is further configured to:

acquire the first map data corresponding to the target anchor locally; and if the first map data does not exist locally, acquire the first map data from the server according to the target anchor identifier.

Optionally, the attribute acquiring module 502 is further configured to:

receive first coordinate system information corresponding to the target anchor identifier sent by the server; acquire the downloaded map data and second coordinate system information corresponding to the downloaded map data; and if the first coordinate system information and the second coordinate system information match, acquire the anchor attribute data of the target anchor from the server according to the target anchor identifier.

The anchor sharing apparatus provided in this embodiment may be used to execute the technical solutions of the embodiment corresponding to FIG. 4, with similar implementation principles and technical effects, which will not be repeated here in this embodiment.

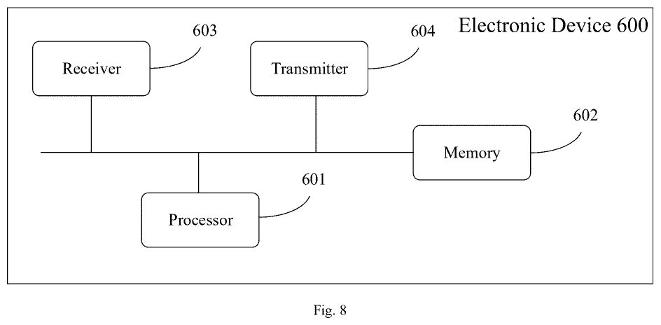

FIG. 8 is a structural block diagram of an electronic device provided by an embodiment of the present disclosure. The electronic device 600 includes a memory 602 and at least one processor 601.

The memory 602 stores computer-executable instructions.

The at least one processor 601 executes the computer-executable instructions stored in the memory 602, causing the electronic device 600 to implement the aforementioned anchor sharing method.

In addition, the electronic device may also include a receiver 603 and a transmitter 604. The receiver 603 is configured to receive information from other devices or apparatuses and forward it to the processor 601, and the transmitter 604 is configured to send information to other devices or apparatuses.

In a first example of the first aspect, an embodiment of the present disclosure provides an anchor sharing method, including:
determining at least one target anchor; acquiring target map data according to the at least one target anchor, where the target map data includes: first map data corresponding to the target anchor, and second map data associated with the first map data; and uploading a target anchor identifier of the target anchor, the target map data, and anchor attribute data corresponding to the target map data to a server.

Based on the first example of the first aspect, in a second example of the first aspect, the uploading the target anchor identifier of the target anchor, the target map data, and the anchor attribute data corresponding to the target map data to the server includes:

acquiring third map data, where the third map data includes map data that has been uploaded to the server and has an overlapping area with the first map data; and if the target anchor is not an anchor corresponding to the third map data, uploading the target anchor identifier of the target anchor, the target map data, and the anchor attribute data corresponding to the target map data to the server.

Based on the second example of the first aspect, in a third example of the first aspect, the method further includes:

if the target anchor is the anchor corresponding to the third map data, uploading the target anchor identifier and a target map identifier of the target map data to the server.

Based on the first to third examples of the first aspect, in a fourth example of the first aspect, the acquiring the target map data according to the at least one target anchor includes:

acquiring the target map data corresponding to the at least one target anchor from an internal memory; and if the target map data does not exist in the internal memory, acquiring the target map data from an external memory.

Based on the first to third examples of the first aspect, in a fifth example of the first aspect, the method further includes:
acquiring first coordinate system information, where the first coordinate system information is used to indicate a coordinate system where the target anchor and the target map data are located; and
uploading the first coordinate system information bound to the target anchor identifier and the target map data to the server.

Based on the first to third examples of the first aspect, in a sixth example of the first aspect, the uploading the target anchor identifier of the target anchor, the target map data, and the anchor attribute data corresponding to the target map data to the server includes:
after uploading the target anchor identifier and the anchor attribute data to the server, uploading, in streaming mode, the target map data corresponding to the target anchor identifier, where an uploading order of the target map data is consistent with an uploading order of the corresponding target anchor identifier.

Based on the first to third examples of the first aspect, in a seventh example of the first aspect, the at least one target anchor includes at least one of the following: an anchor of at least one type, an anchor within at least one region, or an anchor selected by a user.

In a second aspect, embodiments of the present disclosure provide an anchor sharing method, including:

receiving a target anchor identifier sent by a server; if a target anchor corresponding to the target anchor identifier is an anchor in a coordinate system of downloaded map data, acquiring anchor attribute data of the target anchor from the server according to the target anchor identifier; and displaying the target anchor according to the anchor attribute data and the downloaded map data.

Based on a first example of the second aspect, in a second example of the second aspect, after the displaying the target anchor according to the anchor attribute data and the downloaded map data, the method further includes:

acquiring first map data corresponding to the target anchor; and updating the display of the target anchor according to the first map data.

Based on the second example of the second aspect, in a third example of the second aspect, the acquiring the first map data corresponding to the target anchor includes:

acquiring the first map data corresponding to the target anchor locally; and if the first map data does not exist locally, acquiring the first map data from the server according to the target anchor identifier.

Based on the first to third examples of the second aspect, in a fourth example of the second aspect, the if the target anchor corresponding to the target anchor identifier is the anchor in the coordinate system of the downloaded map data, acquiring the anchor attribute data of the target anchor from the server according to the target anchor identifier includes:

receiving first coordinate system information corresponding to the target anchor identifier sent by the server; acquiring the downloaded map data and second coordinate system information corresponding to the downloaded map data; and if the first coordinate system information and the second coordinate system information match, acquiring the anchor attribute data of the target anchor from the server according to the target anchor identifier.

In a third aspect, embodiments of the present disclosure provide an anchor sharing apparatus, including:

a target anchor determination module, configured to determine at least one target anchor; a map acquiring module, configured to acquire target map data according to the at least one target anchor, where the target map data includes: first map data corresponding to the target anchor, and second map data associated with the first map data; and a first uploading module, configured to upload a target anchor identifier of the target anchor, the target map data, and anchor attribute data corresponding to the target map data to a server.

Based on a first example of the third aspect, in a second example of the third aspect, the first uploading module is further configured to:

acquire third map data, where the third map data includes map data that has been uploaded to the server and has an overlapping area with the first map data; and if the target anchor is not an anchor corresponding to the third map data, upload the target anchor identifier of the target anchor, the target map data, and the anchor attribute data corresponding to the target map data to the server.

Based on the second example of the third aspect, in a third example of the third aspect, the apparatus further includes:

a second uploading module, configured to: if the target anchor is the anchor corresponding to the third map data, upload the target anchor identifier and a target map identifier of the target map data to the server.

Based on the first to third examples of the third aspect, in a fourth example of the third aspect, the map acquiring module is further configured to:

acquire the target map data corresponding to the at least one target anchor from an internal memory; and if the target map data does not exist in the internal memory, acquire the target map data from an external memory.

Based on the first to third examples of the third aspect, in a fifth example of the third aspect, the apparatus further includes:

a coordinate acquiring module, configured to acquire first coordinate system information, where the first coordinate system information is used to indicate a coordinate system where the target anchor and the target map data are located; and
a third uploading module, configured to upload the first coordinate system information bound to the target anchor identifier and the target map data to the server.

Based on the first to third examples of the third aspect, in a sixth example of the third aspect, the first uploading module is further configured to:

after uploading the target anchor identifier and the anchor attribute data to the server, upload, in streaming mode, the target map data corresponding to the target anchor identifier, where an uploading order of the target map data is consistent with an uploading order of the corresponding target anchor identifier.

Based on the first to third examples of the third aspect, in a seventh example of the third aspect, the at least one target anchor includes at least one of the following: an anchor of at least one type, an anchor within at least one region, or an anchor selected by a user.

In a fourth aspect, embodiments of the present disclosure provide an anchor sharing apparatus, including:
an anchor receiving module, configured to receive a target anchor identifier sent by a server; an attribute acquiring module, configured to: if a target anchor corresponding to the target anchor identifier is an anchor in a coordinate system of downloaded map data, acquire anchor attribute data of the target anchor from the server according to the target anchor identifier; and an anchor displaying module, configured to display the target anchor according to the anchor attribute data and the downloaded map data.

In a first example of the fourth aspect, an anchor sharing apparatus is provided, and the apparatus includes:
an input area displaying module, configured to display a comment input area for a target region in a table when a first operation instruction for the table is received;
a comment inputting module, configured to receive a selection instruction for a target cell in the comment input area and a first comment inputted in the comment input area, where the target cell includes one or more cells in the target region; and
a comment generating module, configured to generate regional comment content for the target region, where the regional comment content includes the first comment for the target cell.

Based on the first example of the fourth aspect, in a second example of the fourth aspect, the apparatus further includes:
a first map acquiring module, configured to acquire first map data corresponding to the target anchor after displaying the target anchor according to the anchor attribute data and the downloaded map data; and
a target anchor updating module, configured to update the display of the target anchor according to the first map data.

Based on the second example of the fourth aspect, in a third example of the fourth aspect, the first map acquiring module is further configured to:

acquire the first map data corresponding to the target anchor locally; and if the first map data does not exist locally, acquire the first map data from the server according to the target anchor identifier.

Based on the first to third examples of the fourth aspect, in a fourth example of the fourth aspect, the attribute acquiring module is further configured to:

receive first coordinate system information corresponding to the target anchor identifier sent by the server; acquire the downloaded map data and second coordinate system information corresponding to the downloaded map data; and if the first coordinate system information and the second coordinate system information match, acquire the anchor attribute data of the target anchor from the server according to the target anchor identifier.

In a fifth aspect, embodiments of the present disclosure provide an electronic device, including: at least one processor and a memory;

the memory stores computer-executable instructions; and

the at least one processor executes the computer-executable instructions stored in the memory, causing the electronic device to implement the method according to the first aspect or the second aspect.

In a sixth aspect, embodiments of the present disclosure provide an anchor sharing system, including: a sending end, a receiving end and a server, where the sending end is configured to execute the method according to the first aspect, and the receiving end is configured to execute the method according to the second aspect.

In a seventh aspect, embodiments of the present disclosure provide a computer-readable storage medium, where computer-executable instructions are stored in the computer-readable storage medium, and when a processor executes the computer-executable instructions, a computing device is caused to implement the method according to the first aspect or the second aspect.

In an eighth aspect, an embodiment of the present disclosure provides a computer program, where the computer program is configured to implement the method according to the first aspect or the second aspect.

The above description only refers to preferred embodiments of the present disclosure and an explanation to the technical principles as used. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosure concept. For example, a technical solution formed by replacing the above features with technical features having similar functions disclosed in the present disclosure (but not limited to).

In addition, although the operations are described in a specific order, this should not be understood as requiring these operations to be performed in the specific order as shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented, in combination, in a single embodiment. On the contrary, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only example forms for implementing the claims.

1. An anchor sharing method, comprising:
determining at least one target anchor;
acquiring target map data according to the at least one target anchor, wherein the target map data comprises:
first map data corresponding to the target anchor, and second map data associated with the first map data; and
uploading a target anchor identifier of the target anchor, the target map data, and anchor attribute data corresponding to the target map data to a server.

2. The method according to claim 1, wherein uploading the target anchor identifier of the target anchor, the target map data, and the anchor attribute data corresponding to the target map data to the server comprises:
acquiring third map data, wherein the third map data comprises map data that has been uploaded to the server and has an overlapping area with the first map data; and
in response to the target anchor being not an anchor corresponding to the third map data, uploading the target anchor identifier of the target anchor, the target map data, and the anchor attribute data corresponding to the target map data to the server.

3. The method according to claim 2, further comprising:
in response to the target anchor being the anchor corresponding to the third map data, uploading the target anchor identifier and a target map identifier of the target map data to the server.

4. The method according to claim 1, wherein acquiring the target map data according to the at least one target anchor comprises:
acquiring the target map data corresponding to the at least one target anchor from an internal memory; and
in response to the target map data not existing in the internal memory, acquiring the target map data from an external memory.

5. The method according to claim 1, further comprising:
acquiring first coordinate system information, wherein the first coordinate system information is configured to indicate a coordinate system where the target anchor and the target map data are located; and
uploading the first coordinate system information bound to the target anchor identifier and the target map data to the server.

6. The method according to claim 1, wherein uploading the target anchor identifier of the target anchor, the target map data, and the anchor attribute data corresponding to the target map data to the server comprises:
after uploading the target anchor identifier and the anchor attribute data to the server, uploading, in streaming mode, the target map data corresponding to the target anchor identifier, wherein an uploading order of the target map data is consistent with an uploading order of the corresponding target anchor identifier.

7. The method according to claim 1, wherein the at least one target anchor comprises at least one of the following: an anchor of at least one type, an anchor within at least one region, or an anchor selected by a user.

8. An anchor sharing method, comprising:
receiving a target anchor identifier sent by a server;
in response to a target anchor corresponding to the target anchor identifier being an anchor in a coordinate system of downloaded map data, acquiring anchor attribute data of the target anchor from the server according to the target anchor identifier; and
displaying the target anchor according to the anchor attribute data and the downloaded map data.

9. The method according to claim 8, wherein after displaying the target anchor according to the anchor attribute data and the downloaded map data, the method further comprises:
acquiring first map data corresponding to the target anchor; and
updating the display of the target anchor according to the first map data.

10. The method according to claim 9, wherein acquiring the first map data corresponding to the target anchor comprises:
acquiring the first map data corresponding to the target anchor locally; and
in response to the first map data not existing locally, acquiring the first map data from the server according to the target anchor identifier.

11. The method according to claim 8, wherein in response to the target anchor corresponding to the target anchor identifier being the anchor in the coordinate system of the downloaded map data, acquiring the anchor attribute data of the target anchor from the server according to the target anchor identifier comprises:
receiving first coordinate system information corresponding to the target anchor identifier sent by the server;
acquiring the downloaded map data and second coordinate system information corresponding to the downloaded map data; and
in response to the first coordinate system information and the second coordinate system information matching, acquiring the anchor attribute data of the target anchor from the server according to the target anchor identifier.

12. An anchor sharing system, comprising: a sending end, a receiving end, and a server, wherein
the sending end is configured to: determine at least one target anchor; acquire target map data according to the at least one target anchor, wherein the target map data comprises: first map data corresponding to the target anchor, and second map data associated with the first map data; and upload a target anchor identifier of the target anchor, the target map data, and anchor attribute data corresponding to the target map data to a server, and
the receiving end is configured to: receive a target anchor identifier sent by a server; in response to a target anchor corresponding to the target anchor identifier being an anchor in a coordinate system of downloaded map data, acquire anchor attribute data of the target anchor from the server according to the target anchor identifier; and display the target anchor according to the anchor attribute data and the downloaded map data.

13. The system according to claim 12, wherein in uploading the target anchor identifier of the target anchor, the target map data, and the anchor attribute data corresponding to the target map data to the server, the sending end is further configured to:
acquire third map data, wherein the third map data comprises map data that has been uploaded to the server and has an overlapping area with the first map data; and
in response to the target anchor being not an anchor corresponding to the third map data, upload the target anchor identifier of the target anchor, the target map data, and the anchor attribute data corresponding to the target map data to the server.

14. The system according to claim 13, wherein the sending end is further configured to:
in response to the target anchor being the anchor corresponding to the third map data, upload the target anchor identifier and a target map identifier of the target map data to the server.

15. The system according to claim 12, wherein in acquiring the target map data according to the at least one target anchor, the sending end is further configured to:
acquire the target map data corresponding to the at least one target anchor from an internal memory; and
in response to the target map data not existing in the internal memory, acquire the target map data from an external memory.

16. The system according to claim 12, wherein the sending end is further configured to:
acquire first coordinate system information, wherein the first coordinate system information is configured to indicate a coordinate system where the target anchor and the target map data are located; and
upload the first coordinate system information bound to the target anchor identifier and the target map data to the server.

17. The system according to claim 12, wherein in uploading the target anchor identifier of the target anchor, the target map data, and the anchor attribute data corresponding to the target map data to the server, the sending end is further configured to:
after uploading the target anchor identifier and the anchor attribute data to the server,
upload, in streaming mode, the target map data corresponding to the target anchor identifier, wherein an uploading order of the target map data is consistent with an uploading order of the corresponding target anchor identifier.

18. The system according to claim 12, wherein the receiving end is further configured to:
after displaying the target anchor according to the anchor attribute data and the downloaded map data, acquire first map data corresponding to the target anchor; and
update the display of the target anchor according to the first map data.

19. The system according to claim 18, wherein in acquiring the first map data corresponding to the target anchor, the receiving end is further configured to:
acquire the first map data corresponding to the target anchor locally; and
in response to the first map data not existing locally, acquire the first map data from the server according to the target anchor identifier.

20. The system according to claim 12, wherein in acquiring the anchor attribute data of the target anchor from the server according to the target anchor identifier in response to the target anchor corresponding to the target anchor identifier being the anchor in the coordinate system of the downloaded map data, the receiving end is further configured to:
receive first coordinate system information corresponding to the target anchor identifier sent by the server;
acquire the downloaded map data and second coordinate system information corresponding to the downloaded map data; and
in response to the first coordinate system information and the second coordinate system information matching, acquire the anchor attribute data of the target anchor from the server according to the target anchor identifier.
